(19) United States
(12) Patent Application Publication
(10) Pub. No.: US 2002/0107888 A1
(43) Pub. Date: Aug. 8, 2002

(54) Method and system for browsing on-line using numeric keys

(75) Inventors: Chuan-Cheng Chiu, Taipei City (TW); Sayling Wen, Taipei City (TW); Yi Lu, Shang-Hai City (CN)

Correspondence Address: LOWE HAUPTMAN GILMAN & BERNER, LLP, Suite 310, 1700 Diagonal Road, Alexandria, VA, 22314, US

(73) Assignee: INVENTEC ONLINE CORPORATION

(21) Appl. No.: 09/778,788

(22) Filed: Feb. 8, 2001

(51) Int. Cl. G06F 17/21

(52) U.S. Cl. 707/513

(57) ABSTRACT

A method for browsing on-line using numeric keys is provided. The present method comprises the steps of: sorting a plurality of hyperlinks displayed on a web page, marking each of the plurality of hyperlinks with a corresponding number, and connecting to and displaying another web page linked with the hyperlink in response to an input number.

### BACKGROUND OF THE INVENTION

1. Field of the Invention

The present invention relates to a method and a system for browsing on-line; and more particularly to a method and a system for browsing on-line using numeric keys.

2. Description of the Prior Art

Although the interconnection network still broadly employed, the personal computer is no longer a unique tool for going on-line. A certain kind of information appliance such as set-top box provides the capability for going on-line. The set-top box is a kind of equipment with capability of going on-line for browsing through a home television as a display output. FIG. 1A shows a perspective view of the set-top box, a keyboard or a remote control keyboard can be used as peripheral components of the set-top box. FIG. 1B is a block diagram illustrating how to use the set-top box to go on-line through a television set as a display output, in which the input terminal of the set-top box 1 is connected to the Internet, such as through a telephone line, and the output terminal of the set-top box 1 is connected to a television 2. Besides, a keyboard 3 (or a remote control keyboard) can be further connected to the set-top box 1 as the peripheral component thereof. When a user goes on-line for browsing through the set-top box, a web page can be displayed on the television screen. However, comparing with the personal computer, concerning the hyperlink operation between web pages in network, the operation performance of the set-top box is not superior to that of the personal computer. The personal computer has a mouse as an input device. A user can click a hyperlink by the mouse and then enter the related web page in the network. While some kind of information appliance, such as set-top box, is generally not provided with a mouse; therefore, in this environment, it is necessary to execute a hyperlink using a keyboard.

Referring to FIG. 1C, a display of a web page, when a user decides to enter a web page corresponding to a certain hyperlink, it is necessary for moving to a required hyperlink through the upper, lower, right and left arrow keys. Then, pushing the selected arrow key to enter the related web page. The currently selected hyperlink would be framed or displayed in color. When moving to the required hyperlink, one should push the selected arrow key to enter the related web page in the network. When there are many hyperlinks existing in the displayed page, it may take more time to enter a required web page. Moreover, when the arrangement on the currently displayed web page is irregular, somehow the user will not know how to move to the required hyperlink using the upper, lower, right and left arrow keys.

Accordingly, a method and a system for browsing on-line using numeric keys, which lets a user enter a web page corresponding to a required hyperlink more conveniently and rapidly, is provided. The method can significantly reduce the time needed to select a required hyperlink and to enter the required web page.

### SUMMARY OF THE INVENTION

It is therefore an object of the present invention to provide a method and a system for browsing on-line using numeric keys. The hyperlinks on a currently displayed web page are firstly numbered, and thereby a user can directly obtain a required hyperlink-directed web page through inputting the numbering of the hyperlink.

It is also an object of the present invention to provide a method and a system for browsing on-line using numeric keys. In accordance with the present method, a user can select a required hyperlink and enter the related web page for browsing more conveniently and rapidly.

In accordance with these objects, the present invention provides a method and a system for browsing on-line using numeric keys. The present method comprises following steps: sorting a plurality of hyperlinks displayed on a web page, marking each of the plurality of hyperlinks with a corresponding number, and connecting to and displaying another web page linked with the hyperlink in response to an input number.

### BRIEF DESCRIPTION OF THE DRAWINGS

FIG. 1A is a perspective view of a set-top box;

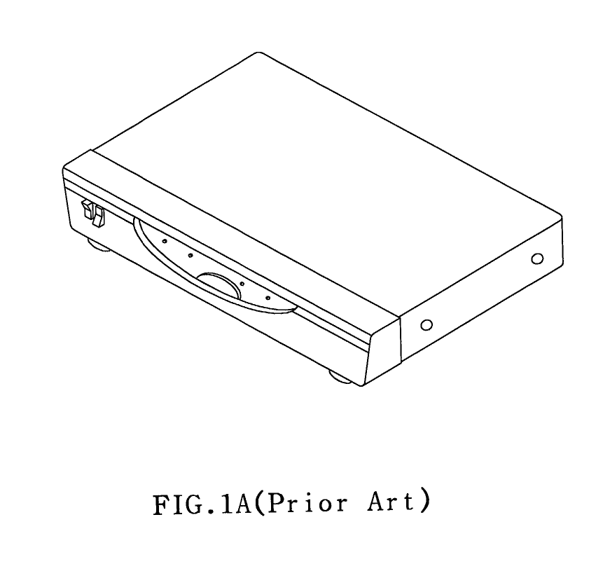

FIG. 1B is a block diagram illustrating using of the set-top box to go on-line;

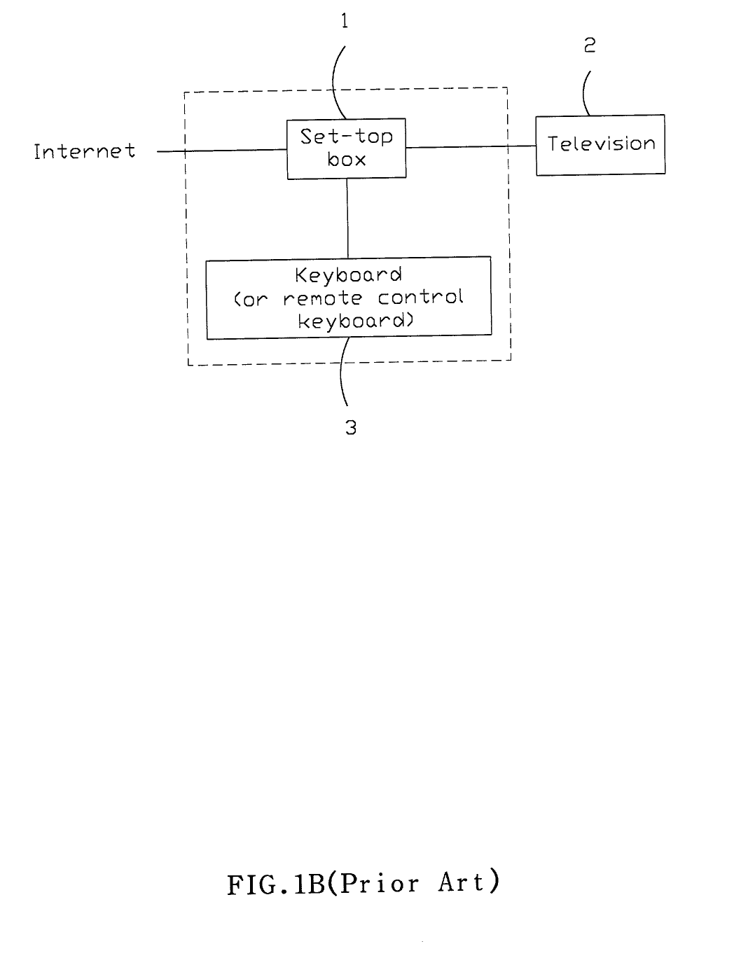

FIG. 1C illustrates a displayed web page of FIG. 1B;

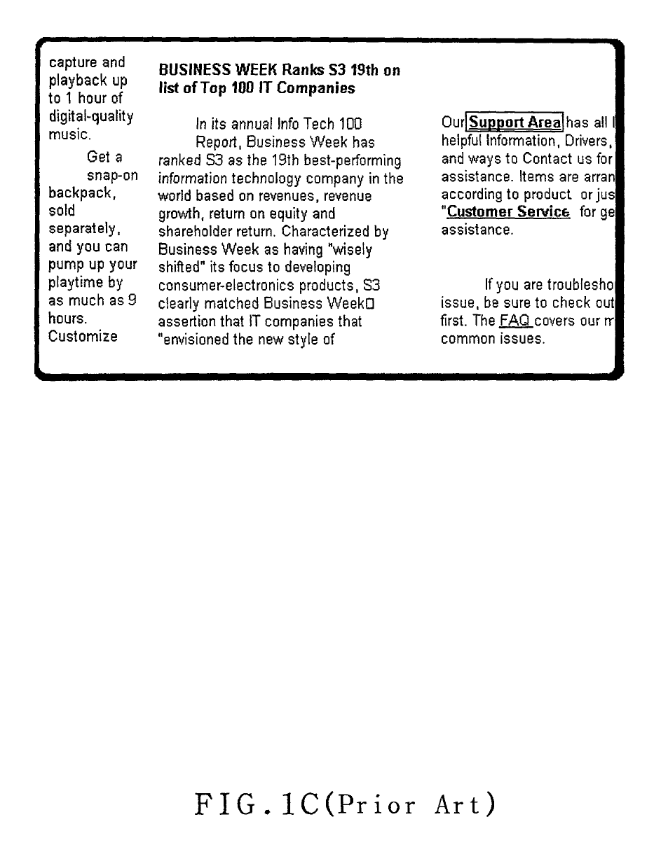

FIG. 2 is a flow diagram of the present invention;

FIG. 3 illustrates a displayed web page according to one embodiment of the present invention when the function of displaying the numberings is chosen;

FIG. 4 is a flow chart for display 40 of FIG. 2; and

FIG. 5 is a flow chart for input 10 of FIG. 2.

### DESCRIPTION OF THE PREFERRED EMBODIMENT

For a browser, interpreting, reading out and displaying of a web page are executed through the program installed therein. The present method for browsing on-line using numeric keys adds the following steps in the original program:

1. sorting a plurality of hyperlinks displayed on a web page;

2. marking each of the pluralities of hyperlinks with a corresponding number;

3. connecting to and displaying another web page associated with the hyperlink in response to an input number.

For the present invention, the numbering definition of each hyperlink can be a predetermined number. In one embodiment, the predetermined number is less than 100, namely a unit number or a two-digit number. When a user decides to input a two-digit number, at first, he rapidly pushes the numeric key related to the tens of the two-digit number twice within a predetermined time, for example, within 0.5 second, and then pushes the numeric key related to the unit digit. When the program detects the user's input, it automatically monitors that a certain numeric key is rapidly pushed twice, the program would determine a two-digit number to be inputted. At first, the inputted numeric key will be related to the tens of the two-digit number. Then, the program waits for the unit digit of the two-digit number input. The program will reset in case that the numeric key of the unit digit is still not inputted while waiting for a period of time after rapidly pushing a certain numeric key twice.

Since the numberings of hyperlinks displayed all the time on the currently displayed web page will influence the user's sight. In the present invention, a function key for hiding/displaying the numberings can be defined in a keyboard served as the input device. The numberings of the hyperlinks can be hidden when the user is browsing web pages in the network, so that the browsing on-line is not interfered. When the user decides to link another web page through hyperlink, the numberings could be displayed, and in accordance with the numberings of hyperlinks, linking to a related web page. After defining the function key for hiding/displaying the numberings, only at the time for displaying the numberings, the input number is considered as a hyperlink's numbering. When the numberings are not displayed, the input number is referred to its original definition. Hence, the functions of some original function keys would not be influenced due to employing the numberings of hyperlinks.

In the present invention, a certain of function keys and hyperlinks displayed in the currently displayed web page can proceed numbering together in accordance with the user's requirement. When a numbering related to a function key is inputted, executing the function key.

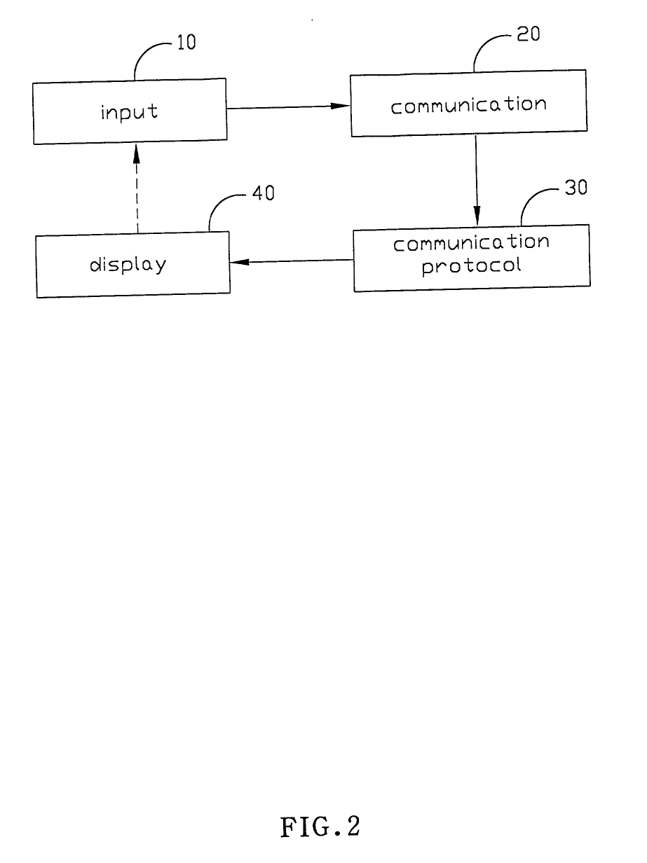

The present method will be described and explained in detail through one preferred embodiment and the accompanying drawings. In the preferred embodiment, the present method is applied to a set-top box. The software of the set-top box consists of four system processing blocks, referring to FIG. 2.

Input 10: it is employed to treat a user's input through an input device. In the preferred embodiment, a remote controller is used as the input device.

Communication 20: it is employed to communicate with the network and retrieve HTML document for an acquired web page in accordance with the user's input.

Communication protocol 30: it is employed to translate the HTML document for display. After the HTML document is translated, there is a set of displayed objects. The displayed object indicated herein is a smallest object which can be completely displayed in one time by display 40, such as an image, a series of text characters having the similar word shape and colors, an input frame and a hyperlink, etc.

Display 40: it is employed to display the displayed objects translated by communication protocol 30. In the preferred embodiment, a television can be used as the display output.

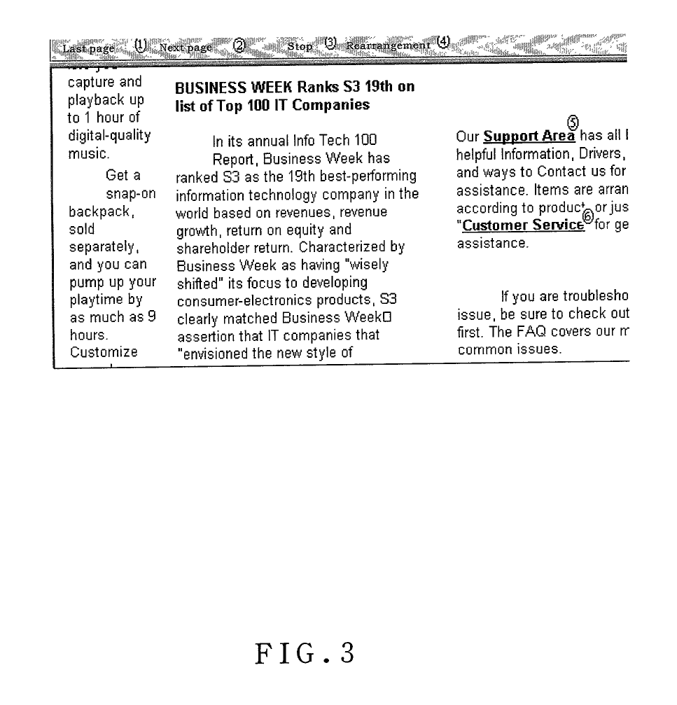

When displaying a web page, display 40 will display each displayed object regularly in accordance with the translated result of communication protocol 30. When the program of the software detects the displayed object is a hyperlink document, the program would proceed numbering for the hyperlink and then saving the relationship between the numbering and the hyperlink in a whole hyperlink table. In the preferred embodiment, there is a function key for hiding/displaying the numberings of the hyperlinks in a remote controller served as the input device. When the user select to display the numbering, display 40 will display a corresponding numbering on the upper right corner of a hyperlink. Besides, in the preferred embodiment, the function keys and the hyperlinks displayed on the currently displayed web page can proceed numbering together, so that the user can operate function keys using the numeric keys. FIG. 3 illustrates a displayed web page when selecting to display the numberings, wherein the numberings 1, 2, 3 and 4 respectively relate to a function key displayed in the currently displayed web page and the numberings 5 and 6 respectively relates to a hyperlink.

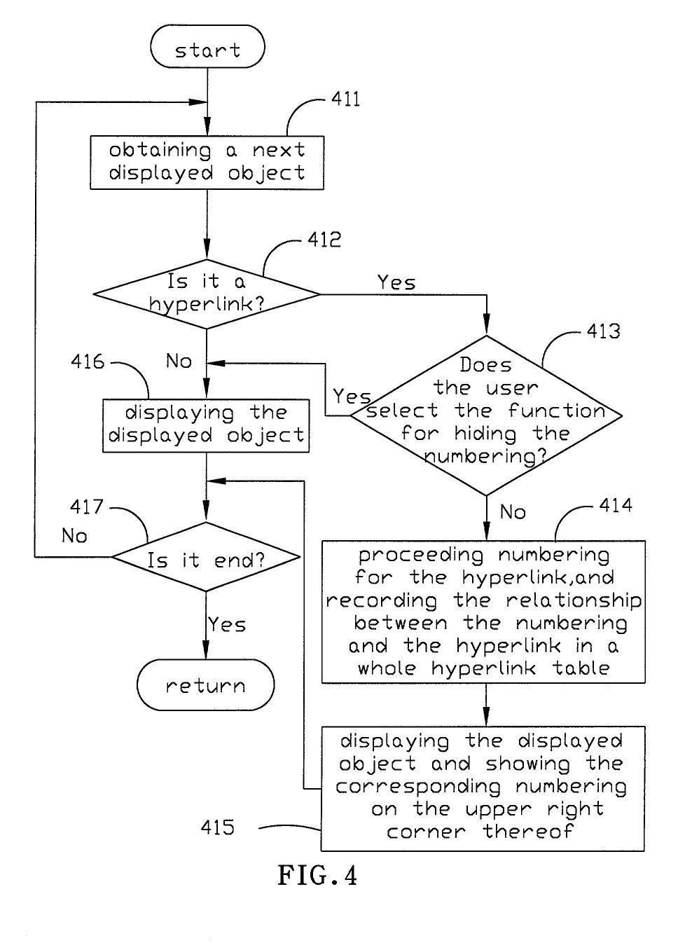

Referring to FIG. 4, it is a flow chart of display 40. Firstly, entering step 411 to obtain a displayed object. Entering step 412 to determine if it is a hyperlink. If it is a hyperlink, entering step 413 to determine if the user select to hide the numbering of the hyperlink. If it does not, entering step 414 to proceed numbering for the hyperlink, and then saving the relationship between the numbering and the hyperlink in a whole hyperlink table. Subsequently, entering step 415 to display the displayed object, and the corresponding numbering is shown on the upper right corner thereof. Then, entering step 417 to determine if it is end. If it is not end, entering step 411 to obtain a next displayed object and repeating the above steps. In step 413, when choosing hiding the numberings, entering step 416 to display the displayed object. Following, entering step 417 to determine if it is end. If it is not end, entering step 411 to obtain a next displayed object. In step 412, if determining it is not a hyperlink, entering step 416 to display the displayed object.

Input 10 is employed in charge of the user's input. When the numberings are displayed, input 10 will determine the input number as a numbering, and then linking to the related hyperlink-directed web page or executing the related function key.

In the preferred embodiment, the numbering definition is less than 100, namely a unit number or a two-digit number. If the number of the hyperlinks on the currently displayed web page is more than one hundred, those hyperlinks exceeding one hundredth one do not proceed numbering. With respect to those hyperlinks, the user can select the required hyperlink through the upper, lower, right and left arrow keys in the original way and select key to enter the related web page. When the user decides to input a two-digit number, at first, rapidly pushing the numeric key related to the tens of the two-digit number twice and then pushing the numeric key related to the unit digit. When the program detects a certain numeric key pushed twice during 0.5 second, the program will determine the user decides to input a two-digit number, and the input numeric key is related to the tens of the two-digit number to be input. Then, the program waits for the numeric key related to the unit digit input. The program will reset in case that the input operation is not continued during four seconds after a certain numeric key is rapidly pushed twice.

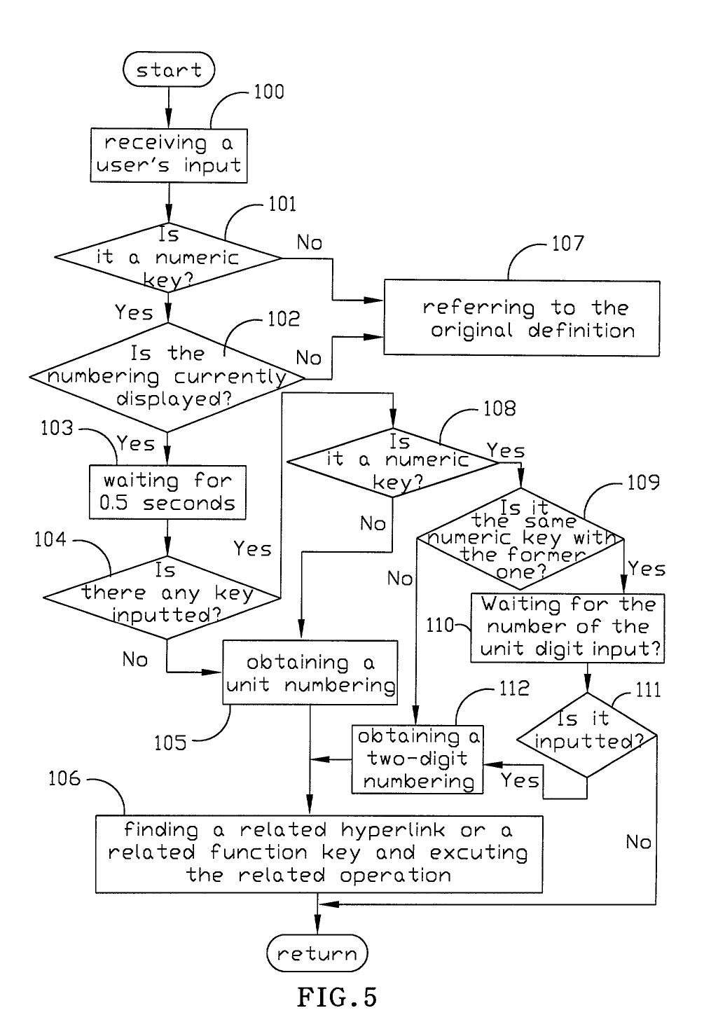

Referring to FIG. 5, it is a flow chart of input 10. At first, entering step 100, receiving a user's input, and then entering step 101 to determine if it is a numeric key. If it is a numeric key, entering step 102 to determine if the numberings are currently displayed. If they are, entering step 103 to wait for 0.5 second. Entering step 104 to determine if there is any key inputted. If there is not a key inputted, entering step 105 to obtain a numbering of a unit number. If there is a key inputted, entering step 108 to determine if it is a numeric key. If it is not a numeric key, entering step 105 to obtain a numbering of a unit number. If it is a numeric key, entering step 109 to determine if it is the same numeric key with the step 101. If it is not the same numeric key, entering step 112 to obtain a numbering of a two-digit number. If it is the same key with the step 101, entering step 110 to wait for the numeric key related to the unit digit input. Entering step 111 to determine if the numeric key related to the unit digit is inputted. If it is inputted, entering step 112 to obtain a numbering of a two-digit number. Following, entering step 106 to obtain the related hyperlink or function key to execute the related operation in accordance with the numbering. In step 111, if determining there is not a numeric key related to the unit digit input, the program will reset. In step 101, if determining there is a non-numeric key inputted, entering step 107 to process the input in accordance with the original definition. In step 102, if determining there is not any numbering on the currently displayed web page, entering step 107 to process the input in accordance with the original definition.

In the preferred embodiment, comparing with the prior method for selecting a hyperlink through the upper, lower, right and left arrow keys, the present method significantly reduces time to search a required hyperlink-directed web page. Besides, there is not a trouble like the prior method that a user somehow does not know how to select a hyperlink through the upper, lower, right and left arrow keys when the arrangement of the currently displayed web page is irregular. By way of the present method, the user can browse on-line more conveniently and rapidly.

The preferred embodiment is only used to illustrate the present invention, not intended to limit the scope thereof. Many modifications of the preferred embodiment can be made without departing from the spirit of the present invention.

What is claimed is:

1. A method for browsing on-line using numeric keys, said method comprising:
sorting a plurality of hyperlinks displayed on a web page;
marking each said plurality of hyperlinks with a corresponding number; and
connecting to and displaying another web page linked with the hyperlink in response to an input number.

2. The method according to claim 1, wherein said marked numbers alternate from being hidden to being displayed in response to a function key.

3. The method according to claim 2, wherein said input number is used to activate the connection of the hyperlinks only when said marked numbers are displayed.

4. The method according to claim 1, wherein range of said marked numbers is less than a predetermined number.

5. The method according to claim 4, wherein said predetermined number is 100.

6. The method according to claim 1, wherein a key of an input device is pushed twice within a predetermined time to represent tens of said input number.

7. The method according to claim 6, wherein said predetermined time is 0.5 second.

8. The method according to claim 1, further comprising sorting and marking at least one defined function displayed on the web page, so that the defined function is activated in response to the corresponding input number.

9. The method according to claim 6, wherein said input device is a remote controller.

10. A hyperlink system comprising:
an input device adapted for receiving input of a user;
a network device configured to acquire information of a web page in response to the input of the user, wherein said information of the web page includes a plurality of hyperlinks which are then sorted and marked with corresponding codes, and wherein information of another web page is further connected to and acquired associated with the hyperlink in response to the code inputted from the user; and
a display device for showing said connected web page.

11. The system according to claim 10, wherein said input device is a remote controller.

12. The system according to claim 10, wherein said network device is a set-top box.

13. The system according to claim 10, wherein range of said marked code is less than a predetermined number.

14. The system according to claim 13, wherein said predetermined number is 100.

15. The system according to claim 10, wherein said marked codes alternate from being hidden to display in response to a function key.

16. The system according to claim 10, wherein said input code is used to activate the connection of the hyperlinks only when said marked codes are displayed.

17. The system according to claim 10, wherein a key of an input device is pushed twice within a predetermined time to represent tens of the input number.

18. The system according to claim 17, wherein said predetermined time is 0.5 second.

19. The system according to claim 10, further comprising sorting and marking at least one defined function displayed on the web page, so that the defined function is activated in response to the corresponding input code.
